(19) United States
(12) Patent Application Publication
(10) Pub. No.: US 2021/0360941 A1
(43) Pub. Date: Nov. 25, 2021

(54) PROCESS FOR MANUFACTURING CONFECTION WITH REDUCED AFTERTASTE

(71) Applicants: Tyler D'Spain, Parker, CO (US); Bethany Kendrick, Denver, CO (US)

(72) Inventors: Tyler D'Spain, Parker, CO (US); Bethany Kendrick, Denver, CO (US)

(21) Appl. No.: 16/881,929

(22) Filed: May 22, 2020

(51) Int. Cl. A23G 3/48; A23L 29/00; A23L 33/115; A23G 3/50; A23G 3/34; A23L 29/25; A23L 29/269; A23L 29/238; A23L 29/256; A23L 29/30

(52) U.S. Cl. CPC A23G 3/48; A23L 29/035; A23L 33/115; A23G 3/50; A23G 3/001; A23L 29/30; A23L 29/25; A23L 29/269; A23L 29/238; A23L 29/256; A23G 3/0014

(57) ABSTRACT

A method for producing a gummy confectionary containing an active ingredient with alternatives to the use of gelatin as a gelling agent. In an embodiment, the active ingredient is cannabidiol (CBD), and the gelling agent is a mixture of plant-based gums and polysaccharides. The method of production comprises the heated activation of the gelling agents in the presence of water and sucrose before adding a sweetener mixture comprising tapioca syrup and sucrose. The active ingredient is introduced as an emulsion of fractionated coconut oil, flavoring, lecithin, and CBD in water. The resultant mixture is colored, and pH adjusted before being molded into the desired shape. The perceived bitterness associated with the use of CBD in a confectionary may be measurably reduced from conventional gelatin and or pectin based confectionary.

### BACKGROUND OF THE INVENTION

### Field of the Invention

The present general inventive concept is directed to a method of manufacture of a confection that is suitable for human consumption with flavor characteristics that reduce the bitter aftertaste common with combined active ingredients.

### Description of the Related Art

Nutritional and active ingredient supplements can be provided in pill or tablet form. It is an advantageous approach to provide supplements such as vitamins as well as active ingredients in a chewable confection to ease the intake or administration of the desired ingredient. In particular, cannabidiol (CBD) has been provided in a gummy confectionary format for ease of administration. The solid form of the gummy provides a robust format for supplements and provides a protective barrier to oxidation, potentially increasing the shelf stability of the CBD. It has been found that a conventional formulation for a gummy confectionary containing a measure dosage of CBD creates the emergence of unpalatable aftertastes. Conventional approaches rely on a combination of ingredients including gelatin and pectin to provide a chewy structure, but combination of these traditional ingredients with active ingredients can result in a bitter aftertaste that reduces both desirability and adaption of the chewable vehicle for the active ingredient.

What is needed is a formulation that provides a chewable confection with an active ingredient that is pleasing in consistency, taste, and aftertaste in order to be desirable as an alternative vehicle for active ingredients.

### SUMMARY OF THE INVENTION

It is an aspect of the present invention to provide a method of manufacture for a palatable confection that when combined with active ingredients including CBD, avoids the unpleasant aftertaste present when the same active ingredients are combined with gelatin. The above aspects can be obtained by utilizing a gum base formulated with agar and locust bean gum, which replaces gelatin as the gum base to give the confectionary its firmness and elasticity. When formulated with appropriate flavoring, the novel gum formulation yields gummies with a lower perceived bitterness. It is a particular aspect of the invention to provide a gummy confectionary for delivering active ingredients consisting essentially of approximately 1.95-2.05% plant-based gum; approximately 24.0-24.2% sucrose; approximately 33.8-34% water; approximately 36-36.2% tapioca syrup; approximately 0.44-0.46% sodium citrate; approximately 0.72-0.74% cannabidiol; approximately 1.68-1.70% fractionated coconut oil; approximately 0.23-0.25% lecithin; approximately 0.25-0.27% natural flavoring; approximately 0.04-0.05% coloring agent; and approximately 0.25-0.26% citric acid.

It is another aspect of the invention to provide a method for producing an edible gummy confection with an active ingredient comprising the steps of preparing a gum mixture by combining agar, locust bean gum, water, and sucrose; activating said gum mixture by heating to produce a gel base; addition of sweetening compounds to said gel base; mixing said sweetening compounds into said gel base; boiling said gel base to achieve Brix in a range of 70 to 74 determined by a refractometer; cooling said gel base to provide a gummy base; preparing an emulsion comprising an active ingredient and a flavoring agent; adding said emulsion to said gummy base; and mixing said emulsion with said gummy base to produce a flavored gummy base.

These together with other aspects and advantages which will be subsequently apparent, reside in the details of formulation and operation as more fully hereinafter described and claimed, reference being had to the accompanying drawings forming a part hereof, wherein like numerals refer to like parts throughout.

### BRIEF DESCRIPTION OF THE DRAWINGS

Further features and advantages of the present invention, as well as the composition and manufacture of various embodiments of the present invention, will become apparent and more readily appreciated from the following description of the preferred embodiments, taken in conjunction with the accompanying FIGURE of which:

FIG. 1 is a flow chart of a method of the invention.

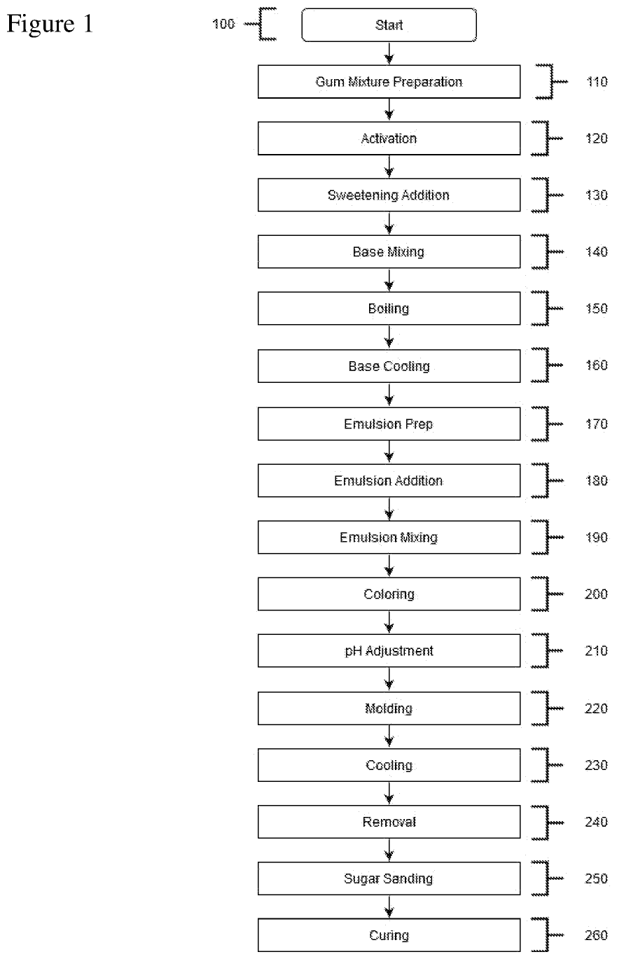

### DESCRIPTION OF THE PREFERRED EMBODIMENTS

Reference will now be made in detail to the presently preferred embodiments of the invention, examples of which are illustrated in the accompanying drawings, wherein like reference numerals refer to like elements throughout.

The present inventive concept relates to a method of producing a chewable confection that carries an active ingredient and provides favorable taste characteristics. Agar consists of a mixture of two polysaccharides: agarose and agaropectin that are derived from seaweed. Locust bean gum is a galactomannan gum thickening agent derived from carob seeds. It has been discovered that combinations of agar, locust bean gum, tapioca syrup, and sucrose, when subjected to a sequence of specific processing conditions can produce a suitable confection with a desirable taste. Both gelatin and pectin, conventional thickening agents, can be avoided in this novel formulation.

In one embodiment of the method of the invention, agar, locust bean gum, sucrose, and water are mixed until uniform in gum mixture preparation step 110. The gum mixture can be prepared in a steam kettle and then heated up to 80 degrees C. and held for 10 minutes in activation step 120 to allow for the agar and locust bean gum to fully activate and form a gel base. Heating can be accomplished in other known manners, but the use of a steam kettle allows for aggressive heating without scorching as steam will not generate an excessive temperature. In a particular embodiment detailed in Table 1, for a batch of about 15,000 gummies, approximately 1.1 to 1.16 kg of an agar and locust bean gum blend are added to 4.5 to 4.52 kg of sucrose, and 1.12 to 1.13 kg of water. In a preferred embodiment, the agar and locust bean gum blend (“gum blend”) must contain 85-99.5% w/w agar and 0.5-15% w/w locust bean gum. One suitable source of an agar and locust bean gum mixture is a proprietary mixture sold as Ticagel GC-553 available from TIC Gums at TICGums.com. Using a 60-gallon steam kettle, heating for approximately 3 hours can achieve a uniform 80 degrees C. Activation can be completed in as little as five minutes at or above 80 degrees C. Completion of the activation step produces a gel base. In an embodiment, a sweetening mixture comprising tapioca syrup can be preheated and mixed with sucrose and sodium citrate to create a sweetening mixture. In an alternate embodiment, the tapioca syrup can be added to the gel base sequentially with the sucrose and sodium citrate in sweetening addition step 130. In an embodiment, workable amounts include about 20 kg of tapioca syrup or about 36-37 percent of the finished product on a w/w basis. Workable amounts of sucrose include about 9 kg in the sweetening mixture. Collectively tapioca syrup and sucrose are referred to as sweetening compounds herein. Sodium citrate can be provided at about one-half percent on a weight basis or about 0.2 to 0.3 kg in the sweetening mixture. More specifically, in the embodiment disclosed in Table 1, approximate amounts include 20.33-20.44 kg of heated tapioca syrup, 9.05-9.15 kg sucrose, and 0.25-0.26 kg of sodium citrate. In a particular embodiment detailed in Table 1, specific amounts include about 20.4 kg of heated tapioca syrup, about 9.1 kg sucrose, and then about 0.25 kg of sodium citrate are sequentially added slowly to the gel base in the steam kettle while mixing, and stirred in base mixing step 140 until a uniform texture is achieved, approximately 10 minutes. The contents of the steam kettle can then be heated to a boil in boiling step 150. The boiling can be continued and the mixture cooked down until 70-74 degrees brix is achieved as measured by a fructose refractometer. A brix measurement of greater than 70 is preferable with a target reading of about 72 brix. Providing a consistent amount of ingredients in the composition of the finished product is important to consistently deliver a known amount of active ingredient for ingestion. Establishing a consistent amount of water has been boiled off can be confirmed by measuring with a refractometer. The heat must then be reduced or removed to allow the temperature to reduce to approximately 85 degrees C., or a range of 80 to 90 degrees C. in base cooling step 160 to provide a gummy base.

In emulsion preparation step 170, an emulsion can be prepared containing flavoring and an active ingredient. To ensure an even distribution of an oil-soluble active ingredient in the aqueous gummy base, the oil phase can be emulsified before addition to the gummy base. The emulsion provides the aqueous solubility necessary to evenly disperse oil into the gummy base, and a sufficient amount of water is needed to ensure encapsulation of oil soluble components. In an embodiment where the active ingredient comprises CBD, and the amounts corresponding to the weight basis composition in Table 1, the CBD emulsion contains about 407-418 g CBD an active ingredient, about 949-960 g fractionated coconut oil a plant based medium chain triglyceride, about 130-141 g liquid sunflower lecithin as an emulsifier, about 1122-1128 g water, and 141-152 g of lemon oil as a flavoring agent. Coconut oil is processed to isolate the octanoic acid and decanoic acid and the result is known as fractionated coconut oil. Liquid sunflower lecithin is amphiphilic and aids in the creation of a well dispersed emulsion. Specific amounts for the embodiment in Table 1 are 410 g CBD, 957 g fractionated coconut oil, 136 g liquid sunflower lecithin, 1125 g of water, and 147 g of lemon oil. The emulsion preparation step 170 can comprise a high shear blender to homogeneously suspend the lemon oil flavoring agent, the CBD active ingredient, the sunflower lecithin emulsifier, and the fractionated coconut oil in the water to create a CBD emulsion. The CBD emulsion is mixed until clear, about 5 to 10 minutes. The CBD emulsion is added to the gummy base in emulsion addition step 180. In emulsion mixing step 190, the contents of the steam kettle are mixed until evenly dispersed using an immersion blender to create the flavored gummy base. In coloring step 200, coloring is added directly to the flavored gummy base, in an embodiment, about 20-25 g of yellow lake FD&C #5 is added and mixed until evenly dispersed to produce a colored gummy base. In the embodiment of Table 1, 23 g of coloring is added.

In pH adjustment step 210, the pH of the colored gummy base can be lowered to a target between 3.8 and 4.0 by adding citric acid, for example about 250 g, until the target pH is reached, to produce a ready gummy base. Lowering the pH provides a tartness to the finished product in combination with sweetness for desirable taste. The pH adjusted ready gummy base can be deposited in molds, for example silicone molds in molding step 220, and remains stable at a temperature between 78 and 88 degrees C. Accurate pouring of the ready gummy base ensures that the confection products comprise consistent volumes and weights. As the prior steps including emulsion ensure homogeneous mixture, consistent and reliable amounts of active ingredients are present in each of the finished confections. The molds can be allowed to cool in cooling step 230 for one hour at room temperature with fresh air exchange. The gummies can then be extracted from the molds in removal step 240 and visually inspected for defects. At this point in the process, stable gummy confections have been achieved with improved flavor characteristics. In order to improve the appearance and increase shelf stability, gummies can be sugar sanded in sugar sanding step 250 using a stand mixer and a mixture of 3% citric acid in sugar. The sanding step both prevents sticking of the confectionary, and provides for greater stability through lower surface water activity and pH. Table 1 shows the amount of citric acid absorbed into the gummy during pH adjustment step 210 and sugar sanding step 250. This amount may vary depending on the amount needed to adjust the pH. Once sanded, gummies can be cured in curing step 260 until a stable water activity (a_{w}) of 0.65 or lower is achieved. Water activity can be measured with a water activity meter. Low water activity levels decrease the risk of microbiological contamination. The high sugar content and lower water activity of the finished gummies effectively inhibits the growth of microorganisms.

TABLE 1
Ingredient formulation in an embodiment of the invention.

| Ingredients | Amounts (w/w) | Weight (kg) |
|---|---|---|
| Ticagel GC-553 | 2.00% | 1.130 |
| Sucrose | 24.10% | 13.610 |
| Water | 33.92% | 19.156 |
| Tapioca syrup | 36.12% | 20.399 |
| Sodium citrate | 0.45% | 0.254 |
| Cannabidiol Isolate | 0.73% | 0.410 |
| Fractionated coconut oil | 1.69% | 0.957 |
| Liquid sunflower lecithin | 0.24% | 0.136 |
| Lemon oil | 0.26% | 0.147 |
| Yellow Lake FD&C #5 | 0.04% | 0.023 |
| Citric Acid | 0.45% | 0.254 |
| Total | 100% | 56.475 kg |

The formulation is based on measured masses. The final percentages are different due to the loss of water in the process.

Analytical results included below in Table 2 show that in a blind taste test, consumers found the gummies formulated with the process of the invention to be less bitter than the gummies formulated using conventional ingredients including gelatin. Each participant was provided 4 gummies, two of each conventional gelatin and the novel agar gummies, each type formulated with the same concentration and types of flavoring, sugars, coloring, and CBD (0.67-0.68% by weight). Participants were asked to rate which gummy was perceived as bitter.

TABLE 2
Gummy comparison of perceived bitterness (% of
participants rating sample as more bitter).

| Ingredients | Agar | Gelatin |
|---|---|---|
| Trial 1 | 58.3% | 41.7% |
| Trial 2 | 33.3% | 66.7% |
| Trial 3 | 25.0% | 75.0% |
| Trial 4 | 50.0% | 50.0% |
| Average | 41.7% | 58.4% |

Given a sample of conventional gelatin gummies and a sample of novel gummies, 58.7% of consumers reported a more prominent bitter taste in the conventional gummies while 41.3% of consumers reported an aftertaste in the novel formulation. The difference in perceived bitterness was compared using a twoAFC sensory discrimination protocol. The p-value measured using the protocol was 0.151, indicating that 1 out of every 6.6 randomized results would yield the measured result. The perceived bitterness is highly variable in the studied population as personal tastes and preferences vary by individual.

Any description of a component or embodiment herein also includes hardware, software, and equipment which already exist in the prior art and may be necessary to the operation of such component(s) or performing steps of the disclosed embodiment(s). Further, the operations described herein can be performed in any sensible order, and any operations not required for achieving the steps of the method can be optional.

The many features and advantages of the invention are apparent from the detailed specification and, thus, it is intended by the appended claims to cover all such features and advantages of the invention that fall within the true spirit and scope of the invention. Further, since numerous modifications and changes will readily occur to those skilled in the art, it is not desired to limit the invention to the exact composition and operation of steps illustrated and described, and accordingly all suitable modifications and equivalents may be resorted to, falling within the scope of the invention. The use of boiling leads to loss of water in the composition of the formulation, and weight percentages will vary slightly based on the water loss.

What is claimed is:

1. A gummy confectionary for delivering active ingredients consisting essentially of:
approximately 1.95-2.05% plant-based gum;
approximately 24.0-24.2% sucrose;
approximately 33.8-34% water;
approximately 36-36.2% tapioca syrup;
approximately 0.44-0.46% sodium citrate;
approximately 0.72-0.74% cannabidiol;
approximately 1.68-1.70% fractionated coconut oil;
approximately 0.23-0.25% lecithin;
approximately 0.25-0.27% natural flavoring;
approximately 0.04-0.05% coloring agent; and
approximately 0.25-0.26% citric acid;

2. The confectionary of claim 1, wherein said plant-based gum is a blend of 85-99.5% agar and 0.5-15% locust bean gum.

3. The confectionary of claim 1, wherein said lecithin comprises liquid sunflower lecithin.

4. The confectionary of claim 1, wherein the natural flavoring is lemon oil.

5. The confectionary of claim 1, wherein the coloring agent is Yellow Lake FD&C #5.

6. A method for producing an edible gummy confection with an active ingredient comprising the steps of:
preparing a gum mixture by combining agar, locust bean gum, water, and sucrose;
activating said gum mixture by heating to produce a gel base;
addition of sweetening compounds to said gel base;
mixing said sweetening compounds into said gel base;
boiling said gel base to achieve Brix in a range of 70 to 74 determined by a refractometer;
cooling said gel base to provide a gummy base;
preparing an emulsion comprising an active ingredient and a flavoring agent;
adding said emulsion to said gummy base; and
mixing said emulsion with said gummy base to produce a flavored gummy base.

7. The method of claim 6 further comprising the step of coloring said flavored gummy base by adding a coloring agent to produce a colored gummy base.

8. The method of claim 7 further comprising the step of adjusting pH of said colored gummy base to provide a ready gummy base.

9. The method of claim 6 wherein the step of preparing a gum mixture further comprises agar of 85-99.5% on a w/w basis and locust bean gum of 0.5-15% on a w/w basis.

10. The method of claim 6 wherein the step of activating said gum mixture comprises heating said gum mixture in a steam vessel to about 80 degrees C. for at least five minutes.

11. The method of claim 6 wherein said addition of sweetening compounds comprises the addition of tapioca syrup on a w/w basis of 36-38%.

12. The method of claim 6 wherein said preparing an emulsion further comprises fractionated coconut oil on a w/w basis of 1.69-1.71% and a lecithin on w/w basis of 0.19-0.21%.

13. The method of claim 6 wherein said active ingredient comprises cannabidiol.

14. The method of claim 6 wherein said flavoring agent comprises lemon oil.
